(19) United States
(12) Patent Application Publication
(10) Pub. No.: US 2021/0234464 A1
(43) Pub. Date: Jul. 29, 2021

(54) POWER CONVERTER, MOTOR DRIVER, AND REFRIGERATION CYCLE APPARATUS

(71) Applicant: Mitsubishi Electric Corporation, Tokyo (JP)

(72) Inventors: Koichi ARISAWA, Tokyo (JP); Takuya SHIMOMUGI, Tokyo (JP); Satoru ICHIKI, Tokyo (JP); Kenji IWAZAKI, Tokyo (JP)

(21) Appl. No.: 17/256,468

(22) PCT Filed: Jul. 26, 2018
(86) PCT No.: PCT/JP2018/028039

§ 371 Date: Dec. 28, 2020

(51) Int. Cl. H02M 3/158; H02M 1/08; H02P 27/06; H02M 1/34; F25B 49/02

(52) U.S. Cl. CPC H02M 3/1586; H02M 1/08; H02P 27/06; F25B 2600/021; F25B 49/025; H02P 2201/09; H02M 1/34

(57) ABSTRACT

There are provided a booster to boost a voltage from a power supply, the booster including multiple stages connected in parallel; and a smoothing device to smooth the boosted voltage. Each of the multiple stages includes: an energy storage to receive current from the power supply and store energy; a switch to switch between connection and disconnection of a path for short-circuiting current from the energy storage; and a backflow preventer to prevent backflow from the smoothing device. At least one of the multiple stages is provided with a characteristic adjuster for adjusting switching characteristics of the switch.

### CROSS REFERENCE TO RELATED APPLICATION

This application is a U.S. national stage application of International Application No. PCT/JP2018/028039 filed on Jul. 26, 2018, the contents of which are incorporated herein by reference.

### TECHNICAL FIELD

The present invention relates to a power converter, a motor driver, and a refrigeration cycle apparatus.

### BACKGROUND

In a motor driver using an inverter, it is common to use a converter that converts alternating-current (AC) power supplied from a power system to direct-current (DC) power. A boost chopper capable of controlling input power to the inverter is often used as the converter for the purpose of drive range expansion, loss reduction, or power factor improvement.

The boost chopper includes a rectifying circuit connected to the power system, a reactor, a switching element, a backflow prevention diode, and a capacitor. The switching element and capacitor are connected between the positive and negative outputs of the rectifying circuit. The reactor is disposed to connect the positive output of the rectifying circuit and the switching element. The backflow prevention diode is disposed to allow current to flow from the positive side of the switching element to the positive side of the capacitor.

The switching element performs power supply short-circuit operation of short-circuiting the outputs of the rectifying circuit by conducting. The power supply short-circuit operation increases the current flowing through the reactor and stores energy in the reactor. In this state, when the switching element is opened, the current flowing through the reactor decreases, and a voltage is generated according to v=L×di/dt.

When the voltage of the reactor is higher than the terminal voltage of the capacitor, the diode conducts, and current flows toward the capacitor and charges the capacitor. When the reactor finishes discharging energy, the voltage decreases, and when the reactor voltage decreases below the capacitor terminal voltage, the backflow prevention diode commutates the current and prevents backflow of current. Thereby, the voltage of the capacitor is maintained.

By repeating the above operation and charging the capacitor, the terminal voltage of the capacitor is increased above the power supply voltage. Thus, the boost chopper can control the input voltage to the inverter.

To reduce the loss in the boost chopper, it is important to make the converter itself have low loss. In particular, in the boost chopper, since switching loss occurs in the switching element for the power supply short-circuit operation required for the voltage control, it is required to reduce the switching loss.

Since the switching loss depends on the switching speed, it can be reduced by applying a switching element using semiconductor, such as silicon carbide (SiC), gallium nitride (GaN), or gallium oxide (Ga₂O₃), having high switching speed.

However, when a switching element having high switching speed is used, noise may instead increase. For example, ringing occurring in the switching element itself due to the switching, ringing due to recovery current generated when the backflow prevention diode commutates the current, or the like often acts as noise.

Thus, to reduce noise, various measures are implemented. For example, Patent Literature 1 discloses a device that, in order to reduce switching noise of a metal-oxide-semiconductor field-effect transistor (MOSFET), includes a capacitor inserted between the drain and the gate and a capacitor inserted between the gate and the source, and adjusts a capacitance by means of a capacitance adjustment switching element to reduce surge.

### PATENT LITERATURE

Patent Literature 1: Japanese Patent Application Publication No. 2017-059920

However, when a booster is formed by using a device of GaN or the like, since the switching speed of the device is fast, there is a problem in that it is likely to be affected by the wiring inductance of an electronic substrate or other factors.

In particular, when a booster is formed by connecting in parallel multiple stages each including a reactor, a switching element, and a diode, the difference between the switching characteristics of the respective stages may increase noise, decreasing the boost efficiency.

### SUMMARY

One or more aspects of the present invention are intended to prevent decrease in boost efficiency of a booster including multiple stages connected in parallel.

A power converter according to an aspect of the present invention includes: a booster to boost a voltage from a power supply, the booster including a plurality of stages connected in parallel; and a smoothing device to smooth the boosted voltage, wherein each of the plurality of stages includes: an energy storage to receive current from the power supply and store energy; a switch to switch between connection and disconnection of a path for short-circuiting current from the energy storage; and a backflow preventer to prevent backflow from the smoothing device, and wherein at least one of the plurality of stages is provided with a characteristic adjuster for adjusting switching characteristics of the switch.

A motor driver according to an aspect of the present invention includes: a power converter; and an inverter to receive power supply from the power converter and generate three-phase alternating-current power, wherein the motor driver includes: a booster to boost a voltage from a power supply, the booster including a plurality of stages connected in parallel; and a smoothing device to smooth the boosted voltage, wherein each of the plurality of stages includes: an energy storage to receive current from the power supply and store energy; a switch to switch between connection and disconnection of a path for short-circuiting current from the energy storage; and a backflow preventer to prevent backflow from the smoothing device, and wherein at least one of the plurality of stages is provided with a characteristic adjuster for adjusting switching characteristics of the switch.

A refrigeration cycle apparatus according to an aspect of the present invention includes: a motor driver including a power converter, and an inverter to receive power supply from the power converter and generate three-phase alternating-current power; and a motor driven by the motor driver, wherein the refrigeration cycle apparatus includes: a booster to boost a voltage from a power supply, the booster including a plurality of stages connected in parallel; and a smoothing device to smooth the boosted voltage, wherein each of the plurality of stages includes: an energy storage to receive current from the power supply and store energy; a switch to switch between connection and disconnection of a path for short-circuiting current from the energy storage; and a backflow preventer to prevent backflow from the smoothing device, and wherein at least one of the plurality of stages is provided with a characteristic adjuster for adjusting switching characteristics of the switch.

According to one or more aspects of the present invention, it is possible to prevent decrease in boost efficiency of a booster including multiple stages connected in parallel.

### BRIEF DESCRIPTION OF DRAWINGS

FIG. 1 is a block diagram schematically illustrating a configuration of a power converter according to a first embodiment.

FIG. 2 is a circuit diagram illustrating an example of a first characteristic adjuster.

FIGS. 3A and 3B are block diagrams illustrating hardware configuration examples.

FIG. 4 is a flowchart illustrating a method of adjusting first characteristic adjusters.

FIGS. 5A and 5B are schematic diagrams illustrating an example of adjustment of a gate resistor.

FIG. 6 is a block diagram schematically illustrating a configuration of a power converter according to a second embodiment.

FIG. 7 is a flowchart illustrating a method of adding a second characteristic adjuster.

FIG. 8 is a flowchart illustrating a method of adjusting first characteristic adjusters and a method of adding the second characteristic adjuster.

FIG. 9 is a block diagram schematically illustrating a configuration of a power converter according to a third embodiment.

FIG. 10 is a flowchart illustrating a method of adding a third characteristic adjuster.

FIG. 11 is a flowchart illustrating a method of adjusting first characteristic adjusters and a method of adding the third characteristic adjuster.

FIG. 12 is a block diagram schematically illustrating a configuration of a power converter according to a fourth embodiment.

FIG. 13 is a flowchart illustrating a method of adding a second characteristic adjuster and a third characteristic adjuster.

FIG. 14 is a flowchart illustrating a method of adjusting first characteristic adjusters, a method of adding the second characteristic adjuster, and a method of adding the third characteristic adjuster.

FIG. 15 is a schematic diagram illustrating a refrigeration cycle apparatus.

### DETAILED DESCRIPTION

### First Embodiment

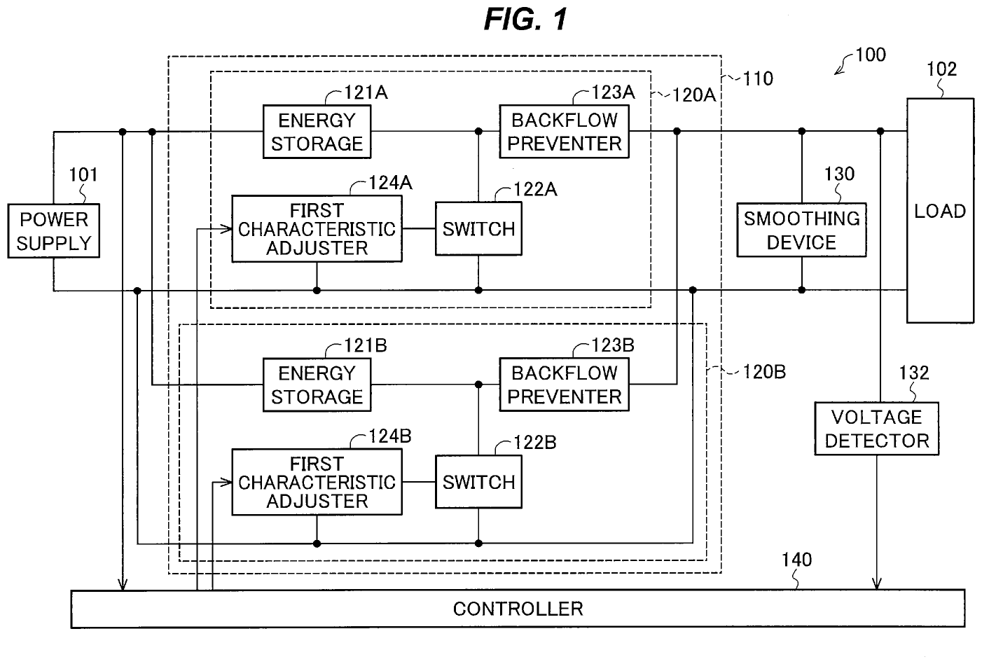

FIG. 1 is a block diagram schematically illustrating a configuration of a power converter 100 according to a first embodiment.

The power converter 100 includes a booster 110, a smoothing device 130, a voltage detector 132, and a controller 140.

The booster 110 includes multiple stages 120A and 120B connected in parallel. The booster 110 boosts a voltage from a power supply 101 and supplies it to the smoothing device 130.

The stage 120A includes an energy storage 121A, a switch 122A, a backflow preventer 123A, and a first characteristic adjuster 124A.

The stage 120B includes an energy storage 121B, a switch 122B, a backflow preventer 123B, and a first characteristic adjuster 124B.

At least one of the multiple stages 120A and 120B is provided with a characteristic adjuster for adjusting the switching characteristics of the switch. In the first embodiment, the stages 120A and 120B are provided with the first characteristic adjusters 124A and 124B, respectively.

Here, when the stages 120A and 120B need not be particularly distinguished from each other, they will be referred to as stages 120.

When the energy storages 121A and 121B need not be particularly distinguished from each other, they will be referred to as energy storages 121.

When the switches 122A and 122B need not be particularly distinguished from each other, they will be referred to as switches 122.

When the backflow preventers 123A and 123B need not be particularly distinguished from each other, they will be referred to as backflow preventers 123.

When the first characteristic adjusters 124A and 124B need not be particularly distinguished from each other, they will be referred to as first characteristic adjusters 124.

The energy storages 121 are connected in common to a positive side of the power supply 101. For example, the energy storages 121 are reactors. The energy storages 121 receive current from the power supply 101 and store energy.

The power supply 101 supplies a direct-current (DC) voltage. For example, the power supply 101 may include a converter that converts an alternating-current (AC) voltage supplied from an AC power supply to a DC voltage.

Each switch 122 is connected between the positive and negative sides of the power supply 101 and performs switching to connect or disconnect the positive and negative sides of the power supply 101. For example, when a switch 122 enters an on state (closed state), the positive and negative sides of the power supply 101 are short-circuited, and current flows through the energy storage 121 and switch 122. In other words, each switch 122 switches between connection and disconnection of a path for short-circuiting current from the energy storage.

Here, the switches 122 are, for example, semiconductor switches, such as MOSFETs or insulated gate bipolar transistors (IGBTs). Wide-bandgap semiconductor may be used in the semiconductor switches, and silicon carbide, gallium nitride, gallium oxide, or diamond may be used in the wide-bandgap semiconductor.

The backflow preventers 123 prevent backflow from the smoothing device 130. For example, the backflow preventers 123 are diodes, such as backflow prevention diodes (fast recovery diodes).

The first characteristic adjusters 124 function as switching drivers that control switching of the switches 122 in accordance with commands from the controller 140. Here, the first characteristic adjusters 124 adjust the switching characteristics of the switches 122 by using switching signals output to the switches 122. For example, a first characteristic adjuster 124 adjusts a switching signal to bring it closer to the switching speed of the switch 122 of the other stage 120, and outputs the adjusted switching signal to the switch 122.

Specifically, when the switches 122 are implemented by semiconductor switches, the first characteristic adjusters 124 can be implemented by gate drive circuits.

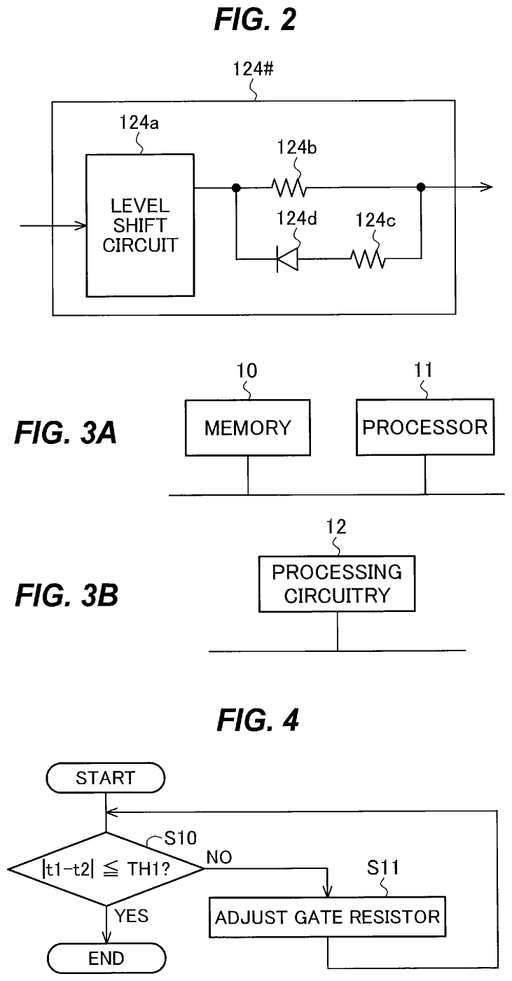

FIG. 2 is a circuit diagram illustrating an example of a first characteristic adjuster 124. FIG. 2 illustrates a gate drive circuit 124 #as a first characteristic adjuster 124.

The gate drive circuit 124 #includes a level shift circuit 124a, a first gate resistor 124b, a second gate resistor 124c, and a diode 124d.

The level shift circuit 124a level-shifts a control signal from the controller 140 to a voltage capable of gate drive, thereby generating a switching signal.

The first gate resistor 124b is a gate resistor used to transmit the switching signal to the switch 122 when the switch 122 is turned from off to on.

The second gate resistor 124c is a gate resistor for removing the gate charge from the switch 122 when the switch 122 is turned from on to off.

The diode 124d is a rectifying means for removing the gate charge from the switch 122 when the switch 122 is turned from on to off.

Here, by changing the resistance of the first gate resistor 124b or second gate resistor 124c, it is possible to adjust the voltage slope of the gate voltage of the switch 122. For example, by increasing the resistance of the first gate resistor 124b, it is possible to decrease the rate of rise of the gate voltage of the switch 122. Likewise, by increasing the resistance of the second gate resistor 124c, it is possible to decrease the rate of fall of the gate voltage of the switch 122.

Returning to FIG. 1, the smoothing device 130 smooths the voltage boosted by the booster 110 and supplies it to a load 102. For example, the smoothing device 130 is an electrolytic capacitor.

The voltage detector 132 detects the voltage output from the smoothing device 130 and provides the detection result to the controller 140.

The controller 140 controls the booster 110 on the basis of the voltage detected by the voltage detector 132. For example, the controller 140 transmits, to the switches 122, control signals for turning on or off the switches 122 of the respective stages 120 included in the booster 110. Here, the controller 140 drives the booster 110 in an interleaving manner by changing phases of the control signals transmitted to the switches 122 of the respective stages 120.

Part or the whole of the above-described controller 140 can be formed by, for example, a memory 10 and a processor 11, such as a central processing unit (CPU), that executes a program stored in the memory 10, as illustrated in FIG. 3A. Such a program may be provided via a network, or may be recorded and provided in a recording medium. Such a program may be provided as a program product, for example.

Also, part or the whole of the controller 140 may be formed by processing circuitry 12, such as a single circuit, a composite circuit, a programmed processor, a parallel-programmed processor, an application specific integrated circuit (ASIC), or a field programmable gate array (FPGA), as illustrated in FIG. 3B, for example.

FIG. 4 is a flowchart illustrating a method of adjusting the first characteristic adjusters 124.

First, a producer of the power converter 100 assesses rise times of the gate voltages of the switches 122A and 122B (S10). Specifically, the producer determines whether a difference (|t1−t2|) between a rise time t1 of the gate voltage of the switch 122A and a rise time t2 of the gate voltage of the switch 122B is not greater than a predetermined first threshold TH1. When the difference is not greater than the first threshold TH1 (Yes in S10), the process ends, and when the difference is greater than the first threshold TH1 (No in S10), the process proceeds to step S11.

In step S11, the producer adjusts the first gate resistor 124b for the switch 122A or 122B. Specifically, when performing the processing of step S10 for the first time after starting the flow of FIG. 4, the producer determines, as a target switch 122 #1, one of the switches 122 having the shorter of the rise times of the gate voltages, and determines, as a reference switch 122 #2, the other of the switches 122 having the longer of the rise times of the gate voltages. Thereafter, in the processing of step S11, the target switch 122 #1 and reference switch 122 #2 are fixed. For example, in a case where, when performing the processing of step S10 for the first time after starting the flow of FIG. 4, the producer determines the switch 122A as the target switch 122 #1 and the switch 122B as the reference switch 122 #2, when performing the processing of step S11 thereafter, the producer treats the switch 122A as the target switch 122 #1 and treats the switch 122B as the reference switch 122 #2.

The producer adjusts the first gate resistor 124b for the target switch 122 #1 to bring the rise time of the gate voltage of the target switch 122 #1 closer to that of the reference switch 122 #2. When the rise time of the gate voltage of the target switch 122 #1 is shorter than the rise time of the gate voltage of the reference switch 122 #2, the producer increases the resistance of the first gate resistor 124b for the target switch 122 #1.

When the increase of the resistance of the first gate resistor 124b for the target switch 122 #1 has made the rise time of the gate voltage of the target switch 122 #1 longer than the rise time of the gate voltage of the reference switch 122 #2, the producer decreases the resistance of the first gate resistor 124b for the target switch 122 #1. Then, the process returns to step S10.

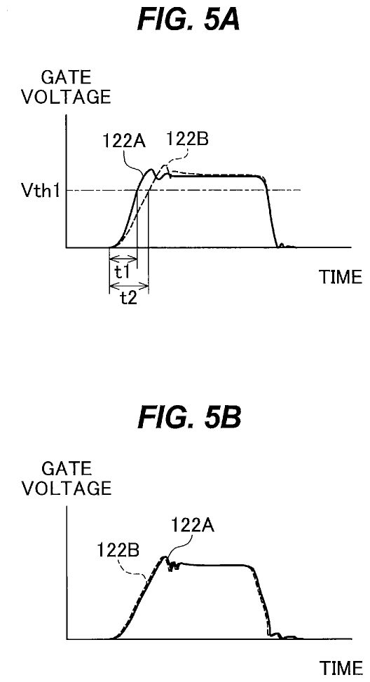

FIGS. 5A and 5B illustrate an example of the adjustment of the gate resistor.

Even when the resistances of the first gate resistors 124b for the switches 122A and 122B are made equal to each other, the rise times of the gate voltages are different from each other due to the effect of wiring inductances around the gates or other factors.

For example, as illustrated in FIG. 5A, when the rise time of the gate voltage of the switch 122B is longer than the rise time of the gate voltage of the switch 122A, the producer increases the resistance of the first gate resistor 124b for the switch 122A.

Thereby, it is possible to equalize the rise time of the gate voltage of the switch 122A and the rise time of the gate voltage of the switch 122B, as illustrated in FIG. 5B.

It is assumed that, as illustrated in FIG. 5A, the rise times t1 and t2 of the gate voltages are each the time from when a switching signal for turning on is input to the switch 122 until the gate voltage of the switch 122 reaches a predetermined threshold voltage Vth1. However, the first embodiment is not limited to such an example.

The flow illustrated in FIG. 4 describes a process in the booster 110 in which the two stages 120A and 120B are arranged in parallel as illustrated in FIG. 1. However, for example, three or more stages may be arranged in parallel.

Even in such a case, it is possible that, when performing the processing of step S10 for the first time after starting the flow of FIG. 4, the producer determines, as a reference switch 122 #2, the switch 122 having the longest of the rise times of the gate voltages, and determines, as target switches 122 #1, the other switches 122, and thereafter, in the processing of step S11, with the target switches 122 #1 and reference switch 122 #2 fixed, makes adjustment so that a difference between each of the rise times of the gate voltages of the target switches 122 #1 and the rise time of the gate voltage of the reference switch 122 #2 is not greater than the first threshold TH1.

Although the flow illustrated in FIG. 4 describes an example focusing on the rise times of the gate voltages, the producer also adjusts fall times of the gate voltages in the same manner.

### Second Embodiment

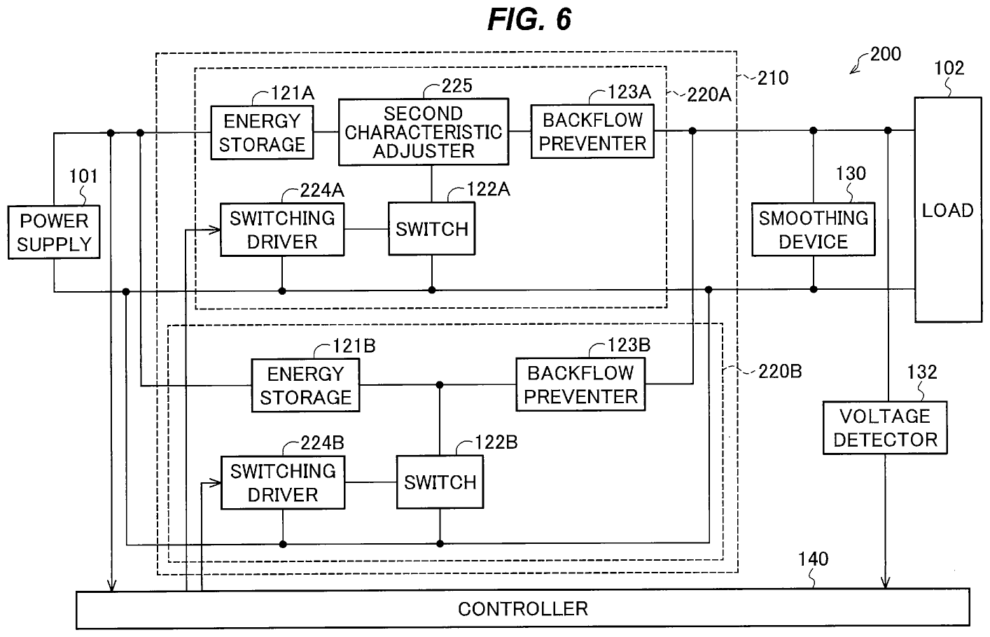

FIG. 6 is a block diagram schematically illustrating a configuration of a power converter 200 according to a second embodiment.

The power converter 200 includes a booster 210, a smoothing device 130, a voltage detector 132, and a controller 140.

The smoothing device 130, voltage detector 132, and controller 140 of the power converter 200 according to the second embodiment are the same as the smoothing device 130, voltage detector 132, and controller 140 of the power converter 100 according to the first embodiment.

The booster 210 includes multiple stages 220A and 220B.

The stage 220A includes an energy storage 121A, a switch 122A, a backflow preventer 123A, a switching driver 224A, and a second characteristic adjuster 225.

The stage 220B includes an energy storage 121B, a switch 122B, a backflow preventer 123B, and a switching driver 224B.

Here, when the stages 220A and 220B need not be particularly distinguished from each other, they will be referred to as stages 220.

When the switching drivers 224A and 224B need not be particularly distinguished from each other, they will be referred to as switching drivers 224.

The switching drivers 224 control switching of the switches 122 in accordance with commands from the controller 140. Specifically, when the switches 122 are implemented by semiconductor switches, the switching drivers 224 can be implemented by gate drive circuits.

The second characteristic adjuster 225 is an inductor-added portion that includes at least an inductor and is used to bring it closer to an inductance component of the other stage 220. For example, the second characteristic adjuster 225 is an inductor or bead inserted to equalize the inductance components of the respective stages 220.

When the booster 210 includes the multiple stages 220, the inductance components of the respective stages 220 may be greatly different. Specifically, the wiring inductance between the energy storage 121A and the backflow preventer 123A may be greatly different from the wiring inductance between the energy storage 121B and the backflow preventer 123B. Also, the wiring inductance between the energy storage 121A and the switch 122A may be greatly different from the wiring inductance between the energy storage 121B and the switch 122B. Further, the wiring inductance between the switch 122A and the backflow preventer 123A may be greatly different from the wiring inductance between the switch 122B and the backflow preventer 123B.

Due to the difference between the inductance components, rise times or fall times of the drain currents of the switches 122 may be different, and the amounts of noise generated in the respective stages 220 may be greatly different.

Thus, a producer of the power converter 200 equalizes the inductance components of all the stages 220 by inserting the second characteristic adjuster 225 in a particular stage 220. Specifically, the producer adds the second characteristic adjuster 225 to one of the multiple stages 220 having the lower inductance value to make it equal to that of the other stage 220.

Although in FIG. 6 the second characteristic adjuster 225 is added to the first stage 220A, the second characteristic adjuster 225 may be inserted in the second stage 220B.

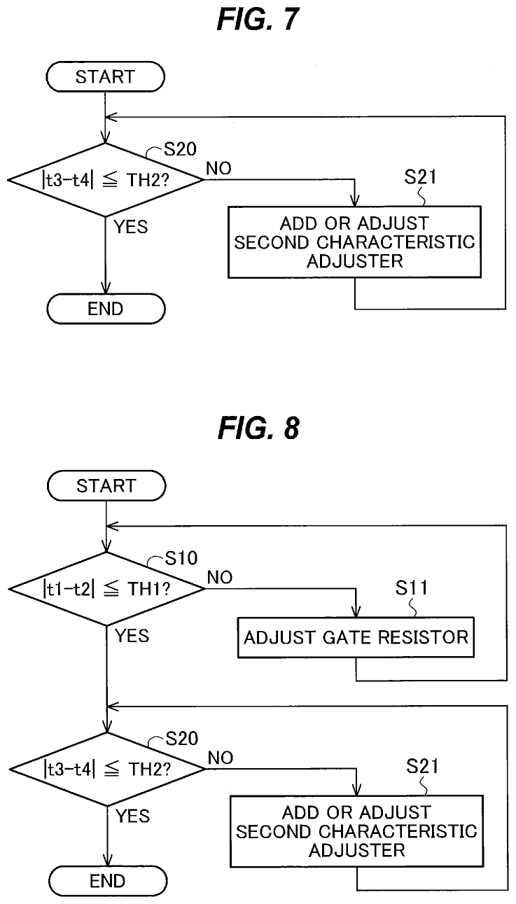

FIG. 7 is a flowchart illustrating a method of adding the second characteristic adjuster 225.

First, a producer of the power converter 200 assesses rise times of the drain currents of the switches 122A and 122B (S20). Specifically, the producer determines whether a difference (|t3−t4|) between a rise time t3 of the drain current of the switch 122A and a rise time t4 of the drain current of the switch 122B is not greater than a predetermined second threshold TH2. When the difference is not greater than the second threshold TH2 (Yes in S20), the process ends, and when the difference is greater than the second threshold TH2 (No in S20), the process proceeds to step S21.

In step S21, the producer measures the rise time t3 of the drain current of the switch 122A and the rise time t4 of the drain current of the switch 122B, and adds the second characteristic adjuster 225 to the stage 220 having the shorter of the times t3 and t4, or adjusts the second characteristic adjuster 225 for the shorter of the times t3 and t4. Specifically, when performing the processing of step S20 for the first time after starting the flow of FIG. 7, the producer determines, as a target switch 122 #3, the switch 122 having the shorter of the rise times of the drain currents, and determines, as a reference switch 122 #4, the switch 122 having the longer of the rise times of the drain currents. Thereafter, in the processing of step S21, the target switch 122 #3 and reference switch 122 #4 are fixed.

Then, the producer brings the rise time of the drain current of the target switch 122 #30 closer to that of the reference switch 122 #4 by adding the second characteristic adjuster 225 to the stage 220 including the target switch 122 #3 or adjusting the second characteristic adjuster added to the stage 220 including the target switch 122 #3.

Specifically, the producer first adds the second characteristic adjuster 225 to the stage 220 including the target switch 122 #3.

Then, when the rise time of the drain current of the target switch 122 #3 is shorter than the rise time of the drain current of the reference switch 122 #4 even after the second characteristic adjuster 225 has been added, the producer adjusts the second characteristic adjuster 225 to increase the inductance value of the second characteristic adjuster 225.

When the addition or adjustment of the second characteristic adjuster 225 has made the rise time of the drain current of the target switch 122 #3 longer than the rise time of the drain current of the reference switch 122 #4, the producer adjusts the second characteristic adjuster 225 to decrease the inductance value of the second characteristic adjuster 225.

The process then returns to step S20.

Thus, it is possible to equalize the rise time of the drain current of the switch 122A and the rise time of the drain current of the switch 122B.

It is assumed that the rise times t3 and t4 of the drain currents are each the time from when a switching signal for turning on is input to the switch 122 until the drain current flowing through the switch 122 reaches a predetermined threshold current. However, the second embodiment is not limited to such an example.

The flow illustrated in FIG. 7 describes a process in the booster 210 in which the two stages 220A and 220B are arranged in parallel as illustrated in FIG. 6. However, for example, three or more stages may be arranged in parallel.

Even in such a case, it is possible that, when performing step S20 for the first time after starting the flow of FIG. 7, the producer determines, as a reference switch 122 #4, the switch 122 having the longest of the rise times of the drain currents, and determines, as target switches 122 #3, the other switches 122, and thereafter, in the processing of step S21, with the target switches 122 #3 and reference switch 122 #4 fixed, makes adjustment so that a difference between each of the rise times of the drain currents of the target switches 122 #3 and the rise time of the drain current of the reference switch 122 #4 is not greater than the second threshold TH2.

Although the flow illustrated in FIG. 7 describes an example focusing on the rise times of the drain currents, the producer also adjusts fall times of the drain currents in the same manner.

Although the power converter 200 according to the second embodiment includes the switching drivers 224, it may include first characteristic adjusters 124 as with the power converter 100 according to the first embodiment, instead of the switching drivers 224.

In such a case, adjustment of the first characteristic adjusters 124 and addition of the second characteristic adjuster 225 may be performed as in the flowchart illustrated in FIG. 8.

The processing in steps S10 and S11 illustrated in FIG. 8 is the same as the processing in steps S10 and S11 illustrated in FIG. 4, and the processing in steps S20 and S21 illustrated in FIG. 8 is the same as the processing in steps S20 and S21 illustrated in FIG. 7.

### Third Embodiment

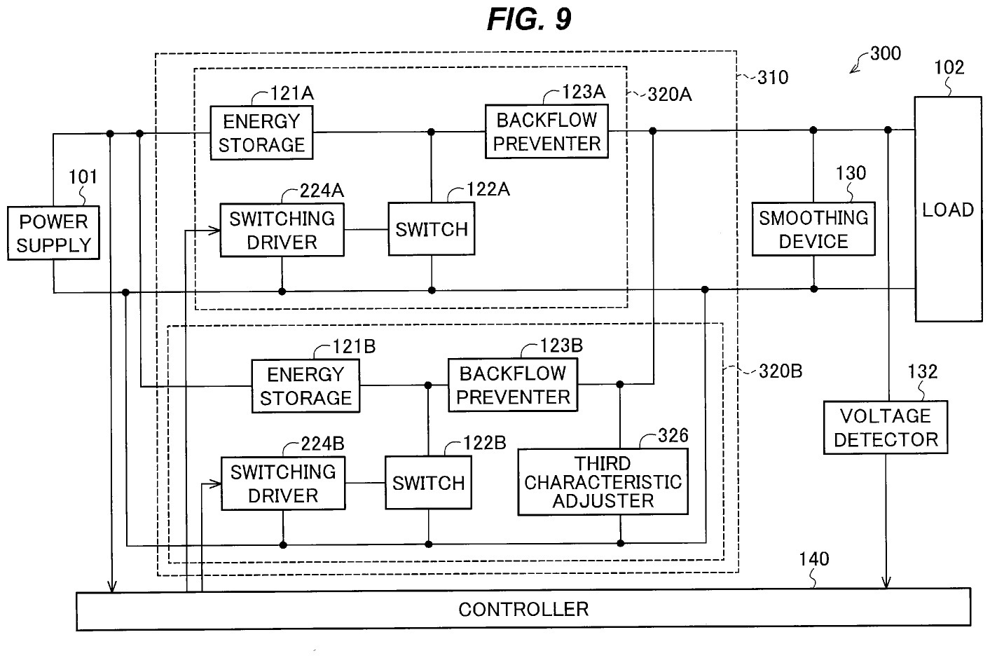

FIG. 9 is a block diagram schematically illustrating a configuration of a power converter 300 according to a third embodiment.

The power converter 300 includes a booster 310, a smoothing device 130, a voltage detector 132, and a controller 140.

The smoothing device 130, voltage detector 132, and controller 140 of the power converter 300 according to the third embodiment are the same as the smoothing device 130, voltage detector 132, and controller 140 of the power converter 100 according to the first embodiment.

The booster 310 includes multiple stages 320A and 320B. The stage 320A includes an energy storage 121A, a switch 122A, a backflow preventer 123A, and a switching driver 224A.

The stage 320B includes an energy storage 121B, a switch 122B, a backflow preventer 123B, a switching driver 224B, and a third characteristic adjuster 326.

Here, when the stages 320A and 320B need not be particularly distinguished from each other, they will be referred to as stages 320.

The switching drivers 224 control switching of the switches 122 in accordance with commands from the controller 140. Specifically, when the switches 122 are implemented by semiconductor switches, the switching drivers 224 can be implemented by gate drive circuits.

The third characteristic adjuster 326 is a snubber circuit connected to bring it closer to a noise component of the other stage 320. The third characteristic adjuster 326 is, for example, a snubber circuit inserted to equalize the noise components of the respective stages 320.

For example, when the booster 310 includes the multiple stages 320, the noise components of the respective stages 320 may be greatly different due to the difference between inductance components of the respective stages 320 or other factors.

Thus, a producer of the power converter 300 equalizes the noise components of all the stages 320 by inserting the third characteristic adjuster 326 in a particular stage 320. Specifically, the producer adds the third characteristic adjuster 326 to one of the multiple stages 320 having the larger noise component to make it equal to that of the other stage 320.

Although in FIG. 9 the third characteristic adjuster 326 is added to the second stage 320B, the third characteristic adjuster 326 may be inserted in the first stage 320A.

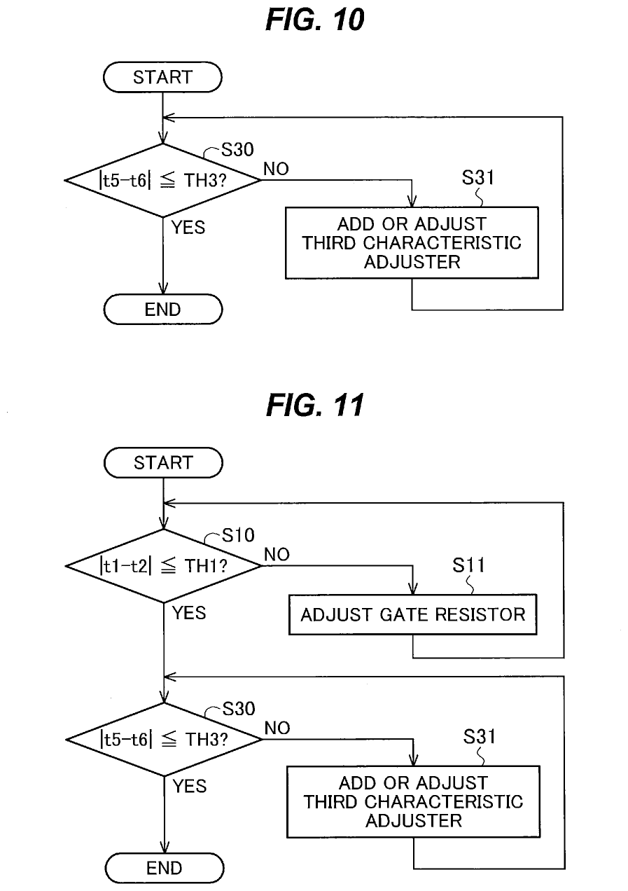

FIG. 10 is a flowchart illustrating a method of adding the third characteristic adjuster 326.

First, a producer of the power converter 300 assesses the time from when the drain-source voltage of the switch 122A starts to rise until ringing of the drain-source voltage converges and the time from when the drain-source voltage of the switch 122B starts to rise until ringing of the drain-source voltage converges (S30). Specifically, the producer determines whether a difference (|t5−t6|) between convergence times t5 and t6 is not greater than a predetermined third threshold TH3, where the convergence time t5 is the time from when the drain-source voltage of the switch 122A starts to rise until ringing of the drain-source voltage converges, and the convergence time t6 is the time from when the drain-source voltage of the switch 122B starts to rise until ringing of the drain-source voltage converges. When the difference is not greater than the third threshold TH3 (Yes in S30), the process ends, and when the difference is greater than the third threshold TH3 (No in S30), the process proceeds to step S31.

In step S31, the producer measures the convergence time t5 of the switch 122A and the convergence time t6 of the switch 122B, and adds the third characteristic adjuster 326 to the stage 320 having the longer of the convergence times t5 and t6, or adjusts the third characteristic adjuster 326 for the longer of the convergence times t5 and t6.

Specifically, when performing the processing of step S30 for the first time after starting the flow of FIG. 10, the producer determines, as a target switch 122 #5, the switch 122 having the longer of the convergence times, and determines, as a reference switch 122 #6, the switch 122 having the shorter of the convergence times. Thereafter, in the processing of step S31, the target switch 122 #5 and reference switch 122 #6 are fixed.

Then, the producer brings the convergence time of the target switch 122 #5 closer to the convergence time of the reference switch 122 #6 by adding the third characteristic adjuster 326 to the stage 320 including the target switch 122 #5 or adjusting the third characteristic adjuster 326 added to the stage 320 including the target switch 122 #5.

Specifically, the producer first adds the third characteristic adjuster 326 to the stage 320 including the target switch 122 #5.

Then, when the convergence time of the target switch 122 #5 is longer than the convergence time of the reference switch 122 #6 even after the third characteristic adjuster 326 has been added, the producer adjusts the third characteristic adjuster 326 to decrease the convergence time of the target switch 122 #5.

When the addition or adjustment of the third characteristic adjuster 326 has made the convergence time of the target switch 122 #5 shorter than the convergence time of the reference switch 122 #6, the producer adjusts the third characteristic adjuster 326 to increase the convergence time of the target switch 122 #5.

The process then returns to step S30.

Thus, it is possible to equalize the convergence time of the drain-source voltage of the switch 122A and the convergence time of the drain-source voltage of the switch 122B.

It is assumed that the convergence times t5 and t6 of the drain-source voltages of the switches 122 are each the time from when a switching signal for turning on is input to the switch 122 until the ringing of the drain-source voltage of the switch 122 converges to within a predetermined range. However, the third embodiment is not limited to such an example.

The flow illustrated in FIG. 10 describes a process in the booster 310 in which the two stages 320A and 320B are arranged in parallel as illustrated in FIG. 9. However, for example, three or more stages may be arranged in parallel.

Even in such a case, it is possible that, when performing the processing of step S30 for the first time after starting the flow of FIG. 10, the producer determines, as a reference switch 122 #6, the switch 122 having the shortest of the convergence times of the drain-source voltages, and determines, as target switches 122 #5, the other switches 122, and thereafter, in the processing of step S31, with the target switches 122 #5 and reference switch 122 #6 fixed, makes adjustment so that a difference between each of the convergence times of the target switches 122 #5 and the convergence time of the reference switch 122 #6 is not greater than the third threshold TH3.

Although the flow illustrated in FIG. 10 describes an example focusing on the convergence times when the drain-source voltages rise, the producer also adjusts convergence times when the drain-source voltages fall, in the same manner.

Although the power converter 300 according to the third embodiment includes the switching drivers 224, it may include first characteristic adjusters 124 as with the power converter 100 according to the first embodiment, instead of the switching drivers 224.

In this case, adjustment of the first characteristic adjusters 124 and addition of the third characteristic adjuster 326 may be performed as in the flowchart illustrated in FIG. 11.

The processing in steps S10 and S11 illustrated in FIG. 11 is the same as the processing in steps S10 and S11 illustrated in FIG. 4, and the processing in steps S30 and S31 illustrated in FIG. 11 is the same as the processing in steps S30 and S31 illustrated in FIG. 10.

### Fourth Embodiment

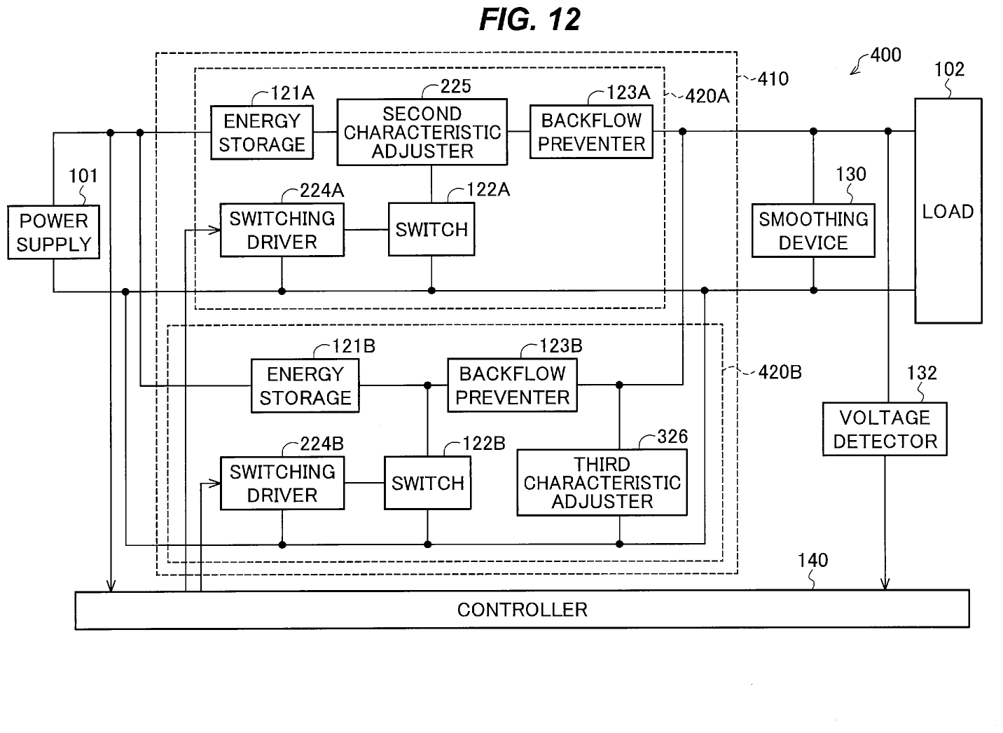

FIG. 12 is a block diagram schematically illustrating a configuration of a power converter 400 according to a fourth embodiment.

The power converter 400 includes a booster 410, a smoothing device 130, a voltage detector 132, and a controller 140.

The smoothing device 130, voltage detector 132, and controller 140 of the power converter 400 according to the fourth embodiment are the same as the smoothing device 130, voltage detector 132, and controller 140 of the power converter 100 according to the first embodiment.

The booster 410 includes multiple stages 420A and 420B.

The stage 420A includes an energy storage 121A, a switch 122A, a backflow preventer 123A, a switching driver 224A, and a second characteristic adjuster 225.

The stage 420B includes an energy storage 121B, a switch 122B, a backflow preventer 123B, a switching driver 224B, and a third characteristic adjuster 326.

Here, when the stages 420A and 420B need not be particularly distinguished from each other, they will be referred to as stages 420.

The switching drivers 224 control switching of the switches 122 in accordance with commands from the controller 140. Specifically, when the switches 122 are implemented by semiconductor switches, the switching drivers 224 can be implemented by gate drive circuits.

The second characteristic adjuster 225 is, for example, an inductor or bead inserted to equalize the inductance components of the respective stages 420.

When the booster 410 includes the multiple stages 420, the inductance components of the respective stages 420 may be greatly different.

Thus, a producer of the power converter 400 equalizes the inductance components of all the stages 420 by inserting the second characteristic adjuster 225 in a particular stage 420. Specifically, the producer adds the second characteristic adjuster 225 to one of the multiple stages 420 having the lower inductance value to make it equal to that of the other stage 420.

Although in FIG. 12 the second characteristic adjuster 225 is added to the first stage 420A, the second characteristic adjuster 225 may be inserted in the second stage 420B.

The third characteristic adjuster 326 is, for example, a snubber circuit inserted to equalize the noise components of the respective stages 420.

When the booster 410 includes the multiple stages 420, the noise components of the respective stages 420 may be greatly different due to the difference between the inductance components of the respective stages 420 or other factors.

Thus, the producer of the power converter 400 equalizes the noise components of all the stages 420 by inserting the third characteristic adjuster 326 in a particular stage 420. Specifically, the producer adds the third characteristic adjuster 326 to one of the multiple stages 420 having the larger noise component to make it equal to that of the other stage 420.

Although in FIG. 12 the third characteristic adjuster 326 is added to the second stage 420B, the third characteristic adjuster 326 may be inserted in the first stage 420A.

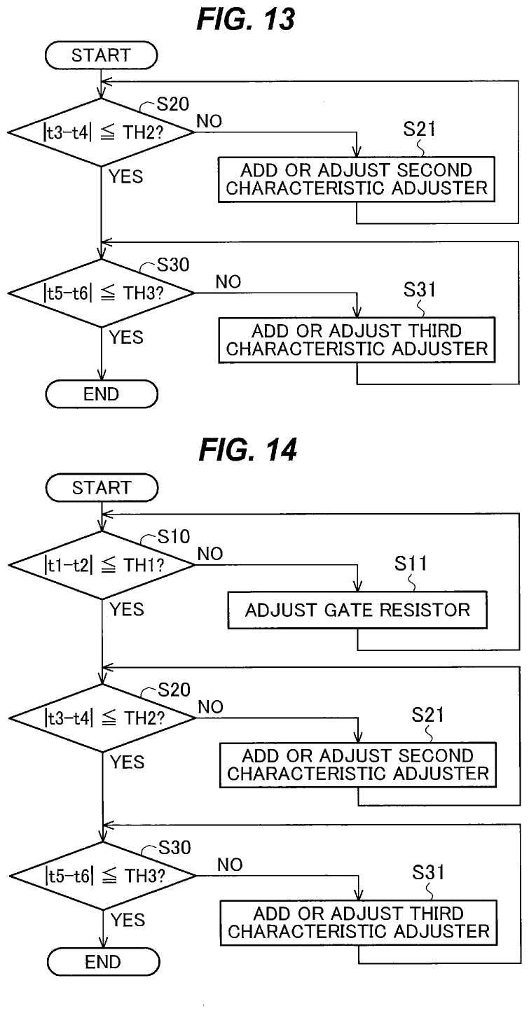

FIG. 13 is a flowchart illustrating a method of adding the second characteristic adjuster 225 and third characteristic adjuster 326.

The processing in steps S20 and S21 of FIG. 13 is the same as the processing in steps S20 and S21 of FIG. 7.

The processing in steps S30 and S31 of FIG. 13 is the same as the processing in steps S30 and S31 of FIG. 10.

Thus, it is possible to equalize the rise time of the drain current of the switch 122A and the rise time of the drain current of the switch 122B, and equalize the convergence time of the drain-source voltage of the switch 122A and the convergence time of the drain-source voltage of the switch 122B.

The flow illustrated in FIG. 13 describes a process in the booster 410 in which the two stages 420A and 420B are arranged in parallel as illustrated in FIG. 12. However, for example, three or more stages may be arranged in parallel.

Even in such a case, the producer can perform addition and adjustment of the second characteristic adjuster 225 and third characteristic adjuster 326 as described in the second and third embodiments.

Also, although the flow illustrated in FIG. 13 describes an example focusing on the rise times of the drain currents, the producer also adjusts fall times of the drain currents in the same manner.

Further, although the flow illustrated in FIG. 13 describes an example focusing on the convergence times when the drain-source voltages rise, the producer also adjusts convergence times when the drain-source voltages fall, in the same manner.

Although the power converter 400 according to the fourth embodiment includes the switching drivers 224, it may include first characteristic adjusters 124 as with the power converter 100 according to the first embodiment, instead of the switching drivers 224.

In such a case, adjustment of the first characteristic adjusters 124, addition of the second characteristic adjuster 225, and addition of the third characteristic adjuster 326 may be performed as in the flowchart illustrated in FIG. 14.

The processing in steps S10 and S11 illustrated in FIG. 14 is the same as the processing in steps S10 and S11 illustrated in FIG. 4, the processing in steps S20 and S21 illustrated in FIG. 14 is the same as the processing in steps S20 and S21 illustrated in FIG. 7, and the processing in steps S30 and S31 illustrated in FIG. 14 is the same as the processing in steps S30 and S31 illustrated in FIG. 10.

By adjusting the first characteristic adjusters 124 in the respective stages 420 and determining placement of the second characteristic adjuster 225 and third characteristic adjuster 326 through the process as described above, it is possible to relatively easily determine the specifications of the first characteristic adjusters 124, second characteristic adjuster 225, and third characteristic adjuster 326, even in a booster 410 that includes many stages and is complicated.

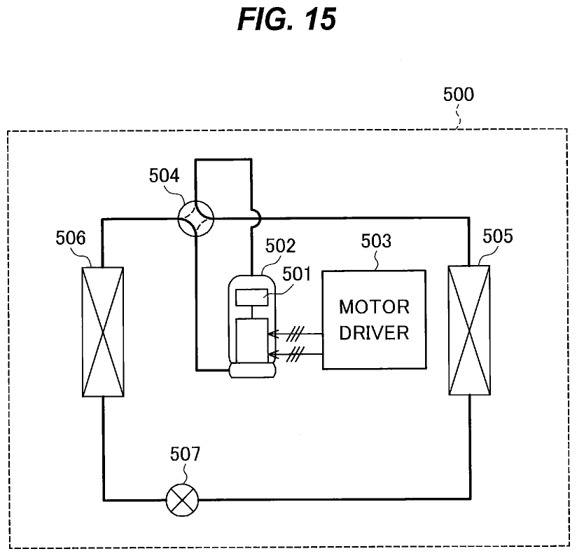

The power converters 100 to 400 as described above can be mounted in a refrigeration cycle apparatus 500 as illustrated in FIG. 15.

For example, the refrigeration cycle apparatus 500 includes a compressor 502 including therein a motor 501, a motor driver 503 that drives the motor 501, a four-way valve 504, heat exchangers 505 and 506, and an expansion valve 507. The power converters 100 to 400 can be mounted in the motor driver 503.

The motor driver 503 includes an inverter (not illustrated) that receives power supply from the power converters 100 to 400 and generates three-phase AC power for driving the motor 501.

The refrigeration cycle apparatus 500 can be used as an air conditioner or a refrigerator.

As above, by providing a characteristic adjuster in at least one of multiple stages connected in parallel, it is possible to equalize switching characteristics of the multiple stages.

For example, by providing, as the characteristic adjuster, an inductor-added portion in a stage requiring it, it is possible to equalize inductance components of the multiple stages.

By providing, as the characteristic adjuster, a snubber circuit, in a stage requiring it, it is possible to equalize noise components of the multiple stages.

By using a switching driver as the characteristic adjuster, it is possible to equalize switching speeds in the multiple stages.

By using, as the characteristic adjuster, a combination of at least two of an inductor-added portion, a snubber circuit, and a switching driver, it is possible to make the switching characteristics more uniform with the characteristic adjuster.

In this case, when a gate drive circuit is used as the switching driver, by adjusting the resistance of a gate resistor, it is possible to easily equalize switching speeds in the multiple stages.

By using a wide-bandgap semiconductor device as the switch, it is possible to perform switching fast. It is desirable that silicon carbide, gallium nitride, gallium oxide, or diamond be used in the wide-bandgap semiconductor device.

By controlling the booster including the multiple stages in an interleaving manner, it is possible to make the switching characteristics more uniform.

1. (canceled)

2. A power converter of comprising:
a booster to boost a voltage from a power supply, the booster including a plurality of stages connected in parallel; and
a smoothing device to smooth the boosted voltage,
wherein each of the plurality of stages includes:
an energy storage to receive current from the power supply and store energy;
a switch to switch between connection and disconnection of a path for short-circuiting current from the energy storage; and
a backflow preventer to prevent backflow from the smoothing device, and
wherein at least one of the plurality of stages is provided with an inductor-added portion including at least an inductor inserted between the energy storage and the backflow preventer to bring an inductance component of the at least one stage closer to inductance components of the plurality of stages except the at least one stage.

3. A power converter of comprising:
a booster to boost a voltage from a power supply, the booster including a plurality of stages connected in parallel; and
a smoothing device to smooth the boosted voltage,
wherein each of the plurality of stages includes:
an energy storage to receive current from the power supply and store energy;
a switch to switch between connection and disconnection of a path for short-circuiting current from the energy storage; and
a backflow preventer to prevent backflow from the smoothing device, and
wherein at least one of the plurality of stages is provided with a snubber circuit connected between the backflow preventer and the smoothing device to bring a noise component of the at least one stage closer to noise components of the plurality of stages except the at least one stage.

4. (canceled)

5. A power converter of comprising:
a booster to boost a voltage from a power supply, the booster including a plurality of stages connected in parallel; and
a smoothing device to smooth the boosted voltage,
wherein each of the plurality of stages includes:
an energy storage to receive current from the power supply and store energy;
a switch to switch between connection and disconnection of a path for short-circuiting current from the energy storage; and
a backflow preventer to prevent backflow from the smoothing device, and
wherein at least one of the plurality of stages is provided with a combination of at least two of a switching driver that adjusts a switching signal for switching between the connection and the disconnection to bring a switching speed of the switch of the at least one stage closer to switching speeds of the switches of the plurality of stages except the at least one stage, and outputs the adjusted switching signal to the switch, an inductor-added portion including at least an inductor inserted between the energy storage and the backflow preventer to bring an inductance component of the at least one stage closer to inductance components of the plurality of stages except the at least one stage, and a snubber circuit connected between the backflow preventer and the smoothing device to bring a noise component of the at least one stage closer to noise components of the plurality of stages except the at least one stage.

6. The power converter of claim 5, wherein
the switches are semiconductor switches,
the switching driver is a gate drive circuit for driving the semiconductor switch, and
the switching speed of the at least one stage is brought closer to the switching speeds of the plurality of stages except the at least one stage by setting a resistance of a gate resistor of the gate drive circuit of the at least one stage to a resistance different from resistances of gate resistors of gate drive circuits of the plurality of stages except the at least one stage.

7. The power converter of claim 6, wherein wide-bandgap semiconductor is used in the semiconductor switches.

8. The power converter of claim 7, wherein silicon carbide, gallium nitride, gallium oxide, or diamond is used in the wide-bandgap semiconductor.

9. The power converter of claim 2, further comprising a controller to control the booster,
wherein the controller controls the plurality of stages in an interleaving manner.

10. A motor driver comprising:
a power converter of claim 2; and
an inverter to receive power supply from the power converter and generate three-phase alternating-current power.

11. A refrigeration cycle apparatus comprising:
a motor driver comprising a power converter of claim 2, and an inverter to receive power supply from the power converter and generate three-phase alternating-current power; and
a motor driven by the motor driver.

12. The power converter of claim 2, further comprising a controller to control the booster,
wherein the controller controls the plurality of stages in an interleaving manner.

13. The power converter of claim 3, further comprising a controller to control the booster,
wherein the controller controls the plurality of stages in an interleaving manner.

14. A motor driver comprising:
a power converter of claim 2; and
an inverter to receive power supply from the power converter and generate three-phase alternating-current power.

15. A motor driver comprising:
a power converter of claim 3; and
an inverter to receive power supply from the power converter and generate three-phase alternating-current power.

16. A refrigeration cycle apparatus comprising:
a motor driver comprising a power converter of claim 2, and an inverter to receive power supply from the power converter and generate three-phase alternating-current power; and
a motor driven by the motor driver.

17. A refrigeration cycle apparatus comprising:
a motor driver comprising a power converter of claim 3, and an inverter to receive power supply from the power converter and generate three-phase alternating-current power; and
a motor driven by the motor driver.
